(19) United States
(12) Patent Application Publication
(10) Pub. No.: US 2003/0142025 A1
(43) Pub. Date: Jul. 31, 2003

(54) Fixing element for a focusing component

(76) Inventors: Bernhard Lucas, Besigheim (DE); Andreas Reichert, Oberstenfeld (DE)

Correspondence Address: KENYON & KENYON, ONE BROADWAY, NEW YORK, NY, 10004, US

(21) Appl. No.: 10/204,650

(22) PCT Filed: Feb. 3, 2001
(86) PCT No.: PCT/DE01/00422

(30) Foreign Application Priority Data
Feb. 23, 2000 (DE) 10008269.6

(51) Int. Cl. H01Q 1/32; H01Q 1/12

(52) U.S. Cl. 343/713; 343/878

(57) ABSTRACT

A support for a focusing component (1) is described, in which the component is attached via fasteners to an object and carries elements (2, 3, 4) which may be focused in a preset signal axis. A support plate (5), which has flexible clips (6, 7) via which the mechanical contact between the component (1) and the object is produced, and which produces the mechanical contact between the component (1) and the object and therefore allows high tolerance compensation of the component (1) during operation, is mounted between the component (1) and the object to which it is attachable.

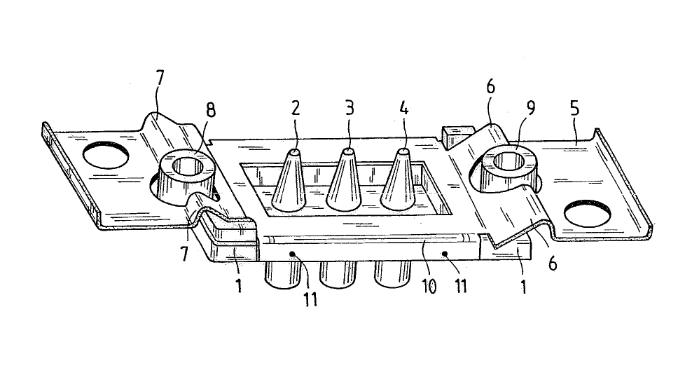

### BACKGROUND INFORMATION

The present invention relates to a support for a focusing component, in particular for an antenna focusing unit on a radar sensor, which may be focused in a preset signal axis and is attached to a motor vehicle, according to the definition of the species in the main claim.

A radar sensor which is fastened with screws to the outside of a vehicle using a support is known from German Patent 197 39 298 C1, for example. This radar sensor may, for example, be a module of a vehicle safety system, in which information about the distance and/or relative speed of the vehicle to other vehicles and to the road surroundings is processed continuously. In this case, it is necessary that the radar sensor be aligned very exactly on the longitudinal axis of the vehicle, i.e., in particular that the focusing of the antenna unit is ensured even over relatively long periods of time.

In the known arrangement, the antenna component, which may be constructed as a polyrod from a special plastic for antennas, is rigidly attached to a structure using standard fasteners, no height tolerance compensation in the signal direction being provided. Since the components are subjected to both manufacturing tolerances and to differing thermal expansions, it may occur in this case that the polyrod disengages via the antenna patch to which it has contact in the radar sensor circuit or it is pressed so strongly against the antenna patch that it deforms elastically. Both mechanisms may reduce the antenna focusing function or cause it to fail completely, which negatively affects the signal transmission of the radar sensor. Furthermore, the polyrod may also strongly deform due to its low intrinsic rigidity which may also result in a reduction or failure of the focusing function.

### ADVANTAGES OF THE INVENTION

A support for a focusing component of the type mentioned in the preamble, in which the component carries elements which may be focused in a preset signal axis, is advantageously refined according to the present invention using the characterizing features of Claim 1. In this case, a support plate, which has flexible clips via which the mechanical contact between the component and the object is produced, is easily attached between the component and the object to which it is attached and therefore height tolerance compensation of the component during operation is made possible.

The support according to the present invention may preferably be provided for attaching a polyrod as a focusing component to a housing of a radar sensor, in particular for a motor vehicle. In this case, the flexible clips ensure constant pressure of the polyrod against the antenna patch on the circuit configuration of the radar sensor over the entire field of application of the component. This constant pressure is necessary in this case for uniform signal transmission of the radar.

The component may advantageously have at least two lateral guide bushings for the fasteners, using which tipping of the component in the region of the flexible movement of the clips is limitable to a preset degree.

Further features, possible applications, and advantages of the present invention emerge from the following description of exemplary embodiments of the present invention, which are illustrated in the figures of the drawing. In this case, all of the features described or illustrated form the object of the invention alone or in any desired combination, independently of their wording in the patent claims or what they refer to and independently of their formulation or illustration in the description or the drawing, respectively.

### DRAWING

An exemplary embodiment of a support according to the present invention for the antenna unit of a radar sensor on a motor vehicle is described with reference to the sole figure of the drawing.

### DETAILED DESCRIPTION OF THE EXEMPLARY EMBODIMENT

In the figure, a perspective illustration of a polyrod 1 may be seen which is constructed as an antenna focusing unit for a radar sensor (not shown in more detail here) known per se from the related art German Patent 197 39 298 C1 cited in the preamble. Individual radiators 2, 3, and 4, using which the radar beams are radiated in a preset signal direction, are arranged on polyrod 1, which is constructed from a special plastic for antennas. Radiators 2 to 4 are connected on the inside [ . . . ] unit for a radar sensor (not shown in more detail here) known per se from the related art German Patent 197 39 298 C1 cited in the preamble. Individual radiators 2, 3, and 4, using which the radar beams are radiated in a preset signal direction, are arranged on polyrod 1, which is constructed from a special plastic for antennas. Radiators 2 to 4 are connected on the inside to an antenna patch of the radar sensor, not shown here.

Polyrod 1 is connected to a support plate 5 which has flexible clips 6 and 7 and, when the arrangement is mounted, comes to rest between polyrod 1 and the housing of the radar sensor or also the bumper of a vehicle to which the radar sensor is attached, for example. Polyrod 1 is to be attached in this case using fasteners which are guided in guide bushings 8 and 9 in such a way that tipping of polyrod 1 in the range of movement of clips 6 and 7 is limited to a preset degree.

Two perpendicular bends 10 which stiffen support plate 5 are attached to support plate 5 in its support on polyrod 1. Furthermore, four locking lugs 11 are attached to polyrod 1 or support plate 5 on the two sides which have bends 10, using which polyrod 1 and support plate 5 may be preassembled.

What is claimed is:

1. An antenna focusing device of a radar sensor, including a focusing component (1) and a support plate (5) which attaches the focusing component (1) to an object,
wherein the support plate (5) has flexible clips (6, 7), via which the mechanical contact between the focusing component (1) and the object is produced, the focusing component (1) being pressed against the antenna patch of the radar sensor at a constant pressure.

2. The device according to claim 1, wherein at least two guide bushings (8, 9) for the fasteners are attached laterally to the focusing component (1), via which tipping of the focusing component (1) in the region of the flexible movement of the clips (6, 7) is limitable to a preset degree.

3. The device according to claim 1 or 2, wherein locking lugs (11) and corresponding opposite locking recesses are provided on the focusing component (1) and the support plate (5) in the non-flexible region of the support plate, via which the support plate (5) is rigidly mountable on the focusing component (1).

4. The device according to one of the preceding claims, wherein perpendicular bends (10) are present on the support plate (5) in the non-flexible region to stiffen the support plate (5).

5. The device according to one of the preceding claims, wherein the support plate (5) is provided for attaching a polyrod (1) as a focusing component on a housing of a radar sensor, in particular for a motor vehicle.
